(19) United States
(12) Patent Application Publication
(10) Pub. No.: US 2025/0004701 A1
(43) Pub. Date: Jan. 2, 2025

(54) MEDIA CONTENT CURATION BASED ON SAMPLE MEDIA ITEM(S)

(71) Applicant: Sonos, Inc., Goleta, CA (US)

(72) Inventors: Ryan MYERS, Goleta, CA (US); Sein WOO, Santa Barbara, CA (US); Konstantin VOVK, Seattle, WA (US)

(21) Appl. No.: 18/754,031

(22) Filed: Jun. 25, 2024

Related U.S. Application Data
(60) Provisional application No. 63/523,754, filed on Jun. 28, 2023.

(51) Int. Cl. G06F 3/16

(52) U.S. Cl. CPC G06F 3/165

(57) ABSTRACT

This disclosure relates to content curation based on sample media items. In some examples, indication(s) of at least one sample media item to be associated with a particular category are received from various accounts of a media service. The sample media items are associated with the particular category, and this association is used to provide, for each account, respective media content recommendations for the particular category. Sample media items provided for the particular category by each account can be different. In this way, media content recommendations provided to each account for the particular category can likewise be different.

### CROSS-REFERENCE TO RELATED APPLICATIONS

This application claims the benefit of and priority to U.S. Provisional Patent Application Ser. No. 63/523,754 filed on Jun. 28, 2023 and entitled “MEDIA CONTENT CURATION BASED ON SAMPLE MEDIA ITEM(S),” which application is expressly incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a bonded playback device.

FIG. 1F is a block diagram of a network microphone device.

FIG. 1G is a block diagram of a playback device.

FIG. 1H is a partial schematic diagram of a control device.

FIG. 2 includes a flowchart for a set of example methods of providing and/or curating media content recommendations based on sample media item(s).

FIG. 3 includes a set of flowcharts for a set of example methods of providing a list of categories to a media service account and/or receiving sample media item(s) for the categories.

FIG. 4A illustrates a first example graphical user interface comprising graphical representations of different categories.

FIG. 4B illustrates a second example graphical user interface.

FIG. 5 illustrates a block diagram comprising example representations of associations in a data structure.

FIG. 6 illustrates a flowchart for a set of methods of providing media content recommendations based on a trigger.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Many people benefit from media content recommendations offered by content providers or other content management services. These content recommendations are typically based on users' playback history so that they are tailored to the users' liking. However, people typically enjoy consuming different types of media content based on different contextual factors, and understanding the kind of content that is most suited for a given context can be challenging. Some content recommendations are based on generic contextual categories such as an activity, a mood, a playback context, etc. associated with content that is commonly played back in a particular context (e.g., working out). However, different people may enjoy different content in different contexts. A “workout” playlist with popular pop songs that some users enjoy when working out may not be appropriate for a user who likes to listen to heavy metal at the gym, even if the user enjoys and/or plays back the popular pop songs in other contexts. Therefore, providing media content recommendations customized to individual users' preferences and curated for a given context could be beneficial.

Some existing solutions provide options of contextual categories among which the user can select (e.g., “dinner”, “running”, etc.). The content recommended for each of those categories may be based on multiple factors. For example, content may be based on a characteristic of the content (e.g., the tempo of a song may indicate that it may be appropriate for relaxing contexts). Content may be based on metadata associated with the content (e.g., metadata can include a category tag or description for the media item). Content may be based on data crowdsourced from multiple users (e.g., what most users listen to in this category), etc. However, the content in these categories may not necessarily be curated to the user's particular consumption preferences in those categories.

Other existing solutions go a step further and involve the selection of a “type” of media content for certain contextual categories. For example, users may indicate the type of content they enjoy consuming for a particular playback context (e.g., when I am cooking, I like listening to jazz; in the office, I like listening to instrumental music, etc.). However, these “types” of content are not necessarily curated to the user's particular liking. In most cases, they are generic categories defined by multiple data such as metadata stored in association with the content (e.g., a jazz song may have associated metadata indicating the genre), or defined based on data crowdsourced from random people (e.g., what instrumental music is popular among other users).

There is a need for curation techniques that allow content to be curated based not only on user payback history and generic contextual categories, but also on the specific content that the user considers relevant to those categories.

This disclosure describes example techniques to address the challenges mentioned above. More specifically, this disclosure describes example techniques for providing media content recommendations based on indications of media content that each user enjoys for particular contextual categories. Some examples involve the use of sample media items provided by each user for the particular categories. These sample media items can be used as seeds for providing media content recommendations for the particular categories. Since different users may provide different sample media items for the same contextual category, different media content recommendations can be provided for those users for that same contextual category.

Referring back to the previous example of providing workout music recommendations, a first user may provide an indication of a pop song for the workout category, while another user may provide an indication of a heavy metal song for this same category. Whenever any of those two users triggers the workout category (e.g., they select the category for playback or engage in the corresponding activity) they can be provided with different content recommendations based on their corresponding sample media items.

As another example, some users may enjoy listening to fast paced music while driving, others may enjoy a more relaxing vibe, and others may enjoy listening to the news and/or podcasts. For a “driving” category, each of those users could provide a sample media item (or more) as a reference of the type of content they'd like to listen to when engaging in this activity. When the driving category is triggered by those users, each of them can be provided with completely different content recommendations based on the corresponding seed.

In this way, content recommendations for different categories of media content can be tailored to the users' specific preferences for the different categories.

In some embodiments, for example, a computing system is provided. The computing system comprises at least one processor and at least one non-transitory computer-readable medium comprising program instructions that are executable by the at least one processor. The computing system may receive, for a first account in a plurality of accounts of a media service, an indication of at least one first sample media item to be associated with a particular category. Additionally, the computing system may receive, for a second account in the plurality of accounts of the media service, an indication of at least one second sample media item to be associated with the particular category, wherein the at least one first sample media item is different from the at least one second sample media item. The computing system may associate, for the first account, the at least one first sample media item with the particular category and associate, for the second account, the at least one second sample media item with the particular category. Based on the association between the particular category and the at least one first sample media item, the computing system may provide for the first account at least one first media content recommendation for the particular category. Based on the association between the particular category and the at least one second sample media item, the computing system may provide for the second account at least one second media content recommendation for the particular category, wherein the at least one second media content recommendation is different from the at least one first media content recommendation.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

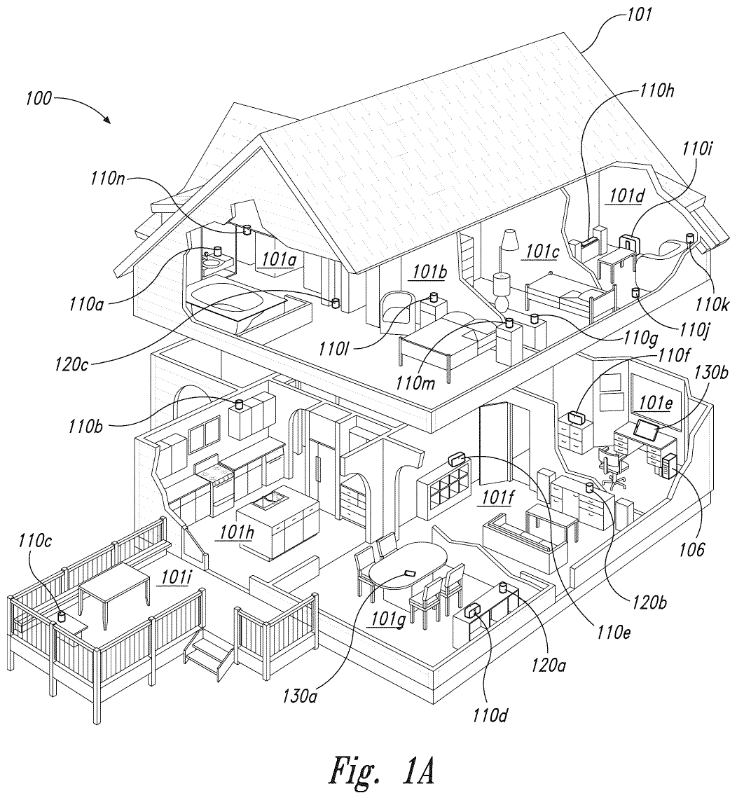

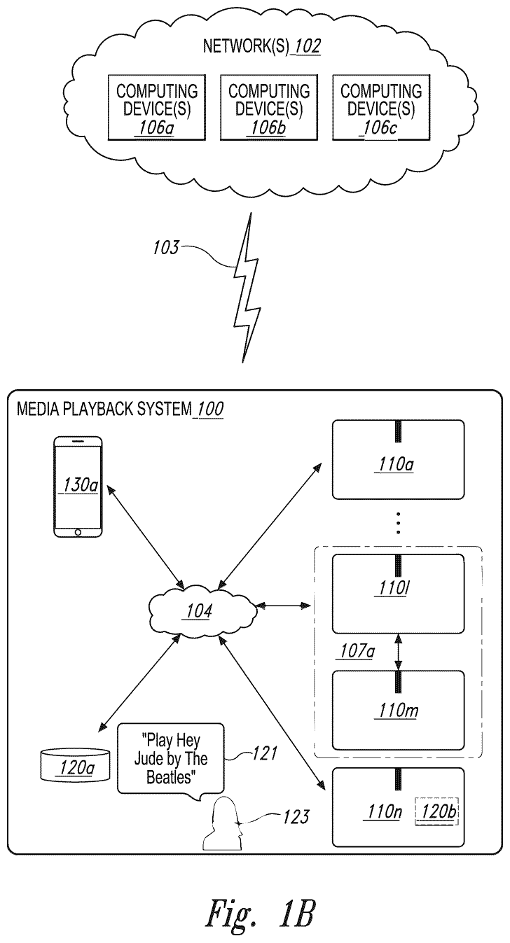

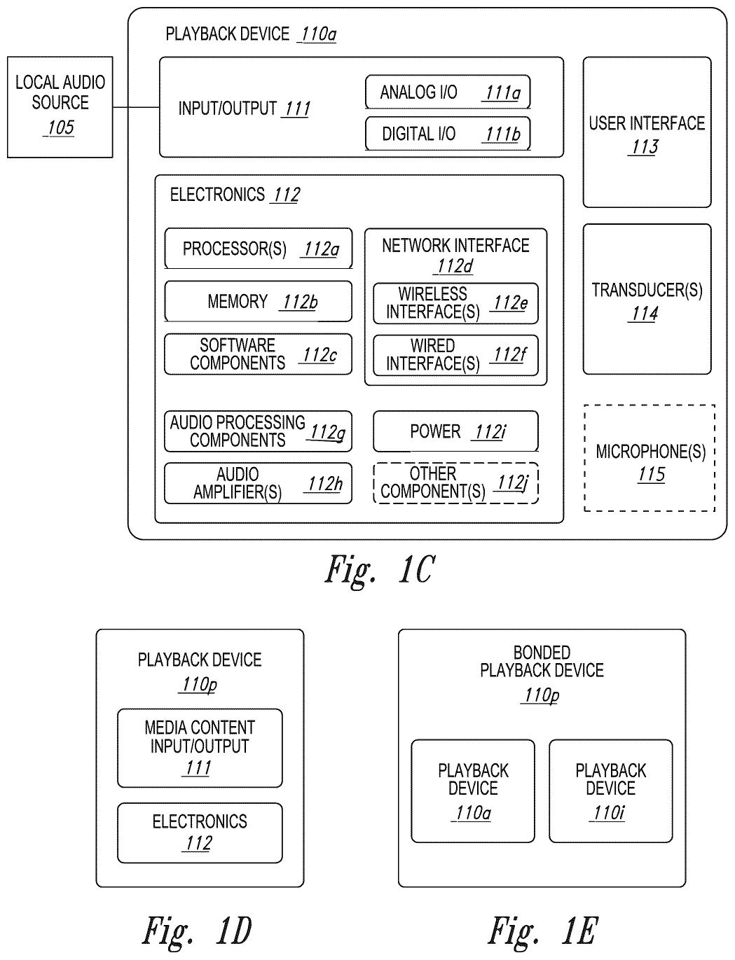

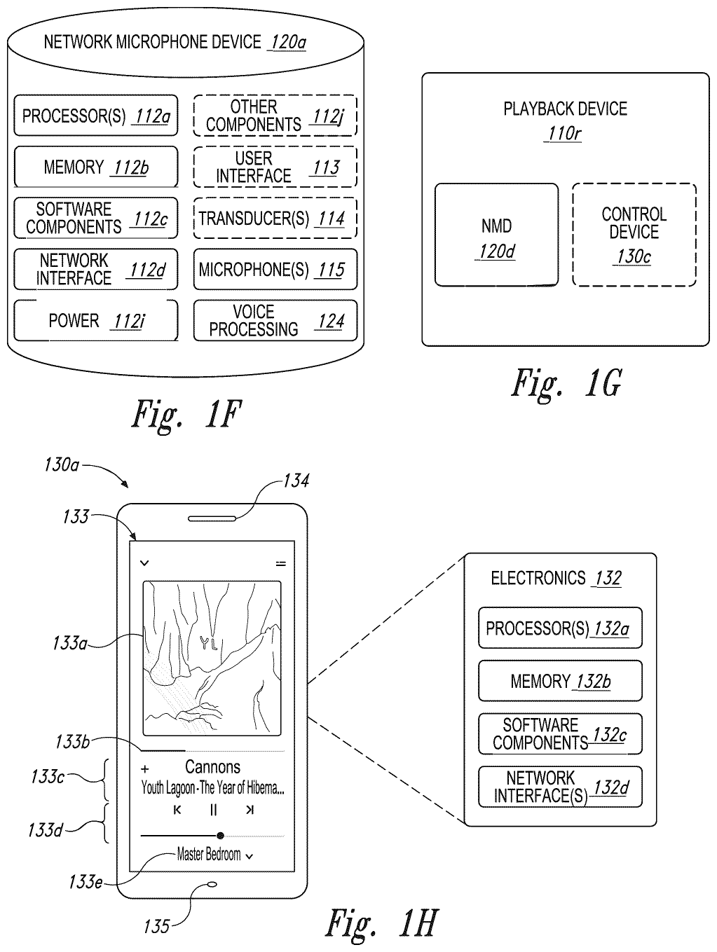

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1H.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

### a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY:1,” “PLAY:3,” “PLAY:5,” “PLAYBAR,” “PLAYBASE,” “CONNECT:AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-car earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### III. Media Content Curation Based on Sample Media Item(s)

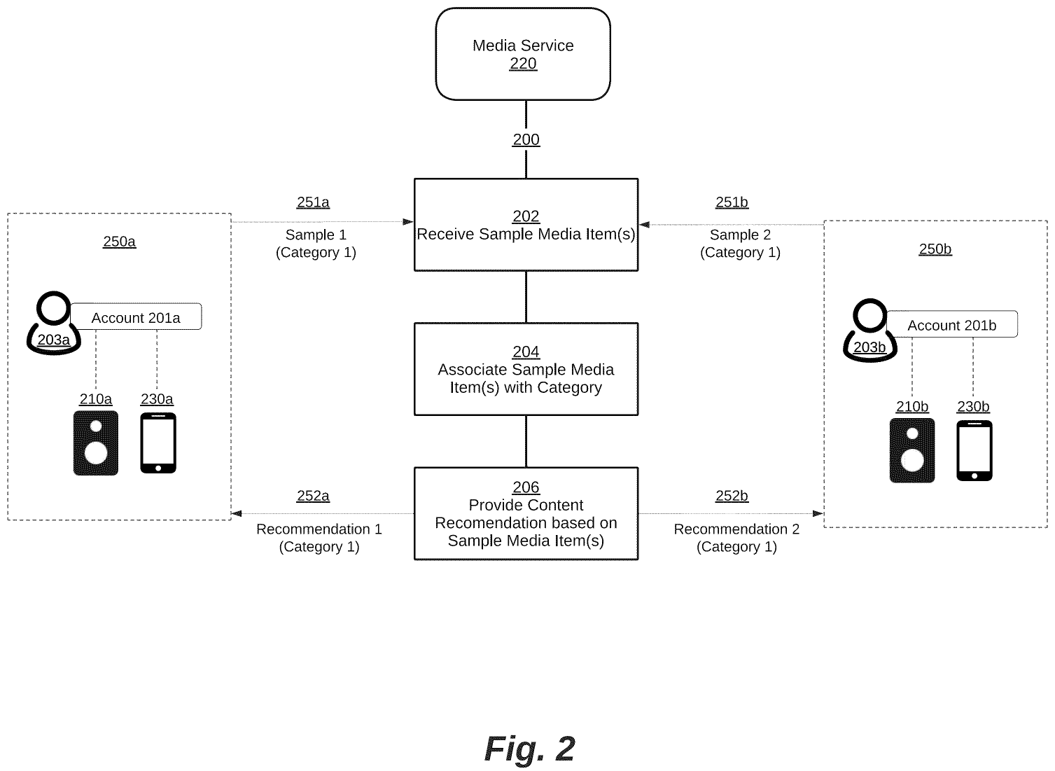

FIG. 2 includes a flowchart 200 for a set of methods of providing and/or curating media content recommendations based on sample media item(s). The different blocks of method 200 can be performed by one or more computing systems associated with one or more media services 220, such as streaming services, content provider and/or content management services, media playback system services, or the like. The computing systems can comprise one or more computing devices (e.g., cloud computing systems, servers, user devices, playback devices, smart devices). The computing systems and/or devices can comprise at least one processor and at least one non-transitory computer-readable medium collectively comprising program instructions that are executable by the at least one processor such that the computing system(s)/device(s) are configured to execute the flowchart blocks.

FIG. 2 also includes example block diagrams 250a and 250b illustrating example scenarios for the execution of the methods in flowchart 200. Block diagrams 250a and 250b illustrate respective accounts 201a and 201b of the media service 220, respective users 203a and 203b, respective user devices 230a and 230b and respective playback devices 210a and 210b. The playback devices 210a/210b can be any of the playback devices 110 described with reference to FIGS. 1A-1H. The user devices 230a/230b can be any of the control devices 130 described with reference to FIGS. 1A-1H. Any of the playback devices 210a/210b or the user devices 230a/230b can be part of respective media playback systems such as the media playback system 100 described with reference to FIGS. 1A-1H. The media playback device/system can be registered with the media service account 201a/201b.

### Receiving Sample Media Items

Flowchart 200 includes a block 202 of receiving indications of one or more sample media items to be associated with a particular category. Sample media items can be received from multiple users (e.g., via their respective accounts with media service(s) 220). As illustrated in a first example arrow 251a, block 202 can include receiving an indication of at least one first sample media item (Sample 1) to be associated with a particular category (Category 1). The first sample media item(s) can be received from a first account 201a of media service 220. The first account 201a can correspond to a first user 203a. User 203a can access their account 201a via any device such as user device 230a and/or a playback device such as playback device 210a. As also illustrated in a second example arrow 251b, block 202 can include receiving an indication of at least one second sample media item (Sample 2) to be associated with the particular category (Category 1). The second sample media item(s) can be received from a second account 201b of media service 220. The second account 201b can correspond to a second user 203b. User 203b can access their account 201b via any device such as user device 230b and/or a playback device such as playback device 210b.

The examples in flowchart 200 include receiving a sample media item (e.g., Sample 1 and Sample 2) from two users/accounts for a particular category (Category 1). However this process, and any others described in this disclosure, can be performed for any number of users/accounts, with any number of sample media items, and for any number of different categories.

In some instances, one or more of the media items received from any of the different users/accounts in block 202 can be different media items. For example, the first sample media item (Sample 1) received from the first account 201a can be different from the second sample media item Sample 2 received from the second account 201b. In some instances, one or more of the media items received from any of the different users/accounts in block 202 can be the same media item(s). For example, the first sample media item (Sample 1) received from the first account 201a could be the same as the second sample media item Sample 2 received from the second account 201b. In some instances, one or more of the media items received from any of the different users/accounts in block 202 can be similar in at least one aspect (e.g., different media items by the same artist, or of the same genre, etc.). For example, the first sample media item (Sample 1) received from the first account 201a could have a characteristic (artist, genre, style, lyrics, tempo, etc.) in common with the second sample media item Sample 2 received from the second account 201b.

As mentioned before in this disclosure, a category, such as Category 1 in the example of FIG. 2, can comprise an activity (e.g., what the user is doing and/or will do and/or wants to do), a mood (e.g., how the user is feeling and/or wants to feel), or any other playback context indication (where, when and/or how the user is playing back content and/or will play back content). Example activities can include working out, cooking, driving, reading, etc. Example moods can include happy, sad, relaxing, etc. Example playback contexts can include a playback device via which media content is to be played back such as a playback device type, a playback device name, playback device status (e.g., grouped, ungrouped, etc.), etc.; a location in which media content is to be played back such as the user's physical location (e.g., at the gym or at home), the listening room (room type, room name); or a time at which media content is to be played back such as a date, a season, a time of the day (mornings, evenings, etc.), etc. Other categories are possible.

In some instances, the categories can be predefined categories provided and/or defined by the media service 220. The media service can provide a list of one or more categories to all the users/user accounts of the media service so that users can playback content in the category and/or provide sample media items if so desired. In some instances, the list of categories and/or categories in the list cannot be changed, and the users/accounts can be allowed to provide sample media items for each category in the list but prevented from modifying the list of categories (e.g., prevented from changing category names or from adding new categories that are not in the list). In this way, all users of the media service can have the same list of categories in their accounts, and each category can be associated with different media content for different accounts (based on the sample media items).

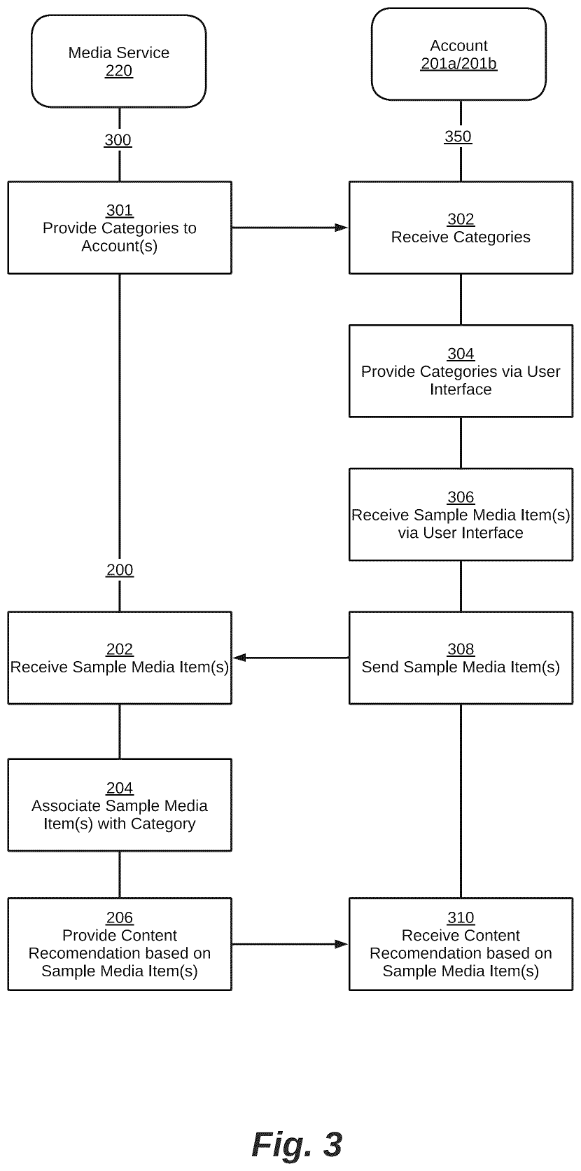

In some instances, before receiving the indication of at least one sample media item in block 202, the list of categories can be transmitted to each account. FIG. 3 includes a set of flowcharts 300 and 350 for a set of methods of providing a list of categories to a media service account and/or receiving sample media item(s) for the categories.

Flowchart 300 includes a block 301 of, before receiving the indication of at least one sample media item to be associated with the particular category from each account, provide a list of at least one category to the user(s)/user account(s). The list of categories can be transmitted in one or more messages to respective devices associated with each account (e.g., a user device such as user devices 230a and 230b, a control device of a media playback system or a playback device of the media playback system such as playback devices 210a and 210b, etc.).

The list of categories can be provided via respective user interfaces associated with each account. Block 301 can include causing respective user interfaces of each account to provide the categories. For example, the user interface can comprise a display of a display device associated/registered with a media service account, and block 301 can comprise causing the display device to display a graphical representation corresponding to the categories in the list of categories. As another example, the user interface can comprise a voice user interface of a playback device associated/registered with the media service account, and block 301 can include causing the playback device to play back auditory messages corresponding to the categories in the list of categories.

Flowchart 350, on the other hand, includes the corresponding accounts receiving the list of categories in block 302. The blocks in flowchart 350 can be performed by any device associated with the user/user account receiving the list of categories. For example, flowchart 350 can be performed by a user device (e.g., 230a/230b) and/or a playback device (e.g., 210a/210b) registered with the media service account (e.g., 201a/201b).

Flowchart 350 includes a block 304 of providing the list of categories to the user(s)/user account(s). Block 304 can include providing the categories via user interfaces corresponding to each account. For example, the user interface can comprise a display of a display device associated/registered with a media service account, and block 304 can comprise displaying a graphical representation corresponding to the categories in the list of categories. As another example, the user interface can comprise a voice user interface of a playback device associated/registered with the media service account, and block 304 can include playing back auditory messages corresponding to the categories in the list of categories.

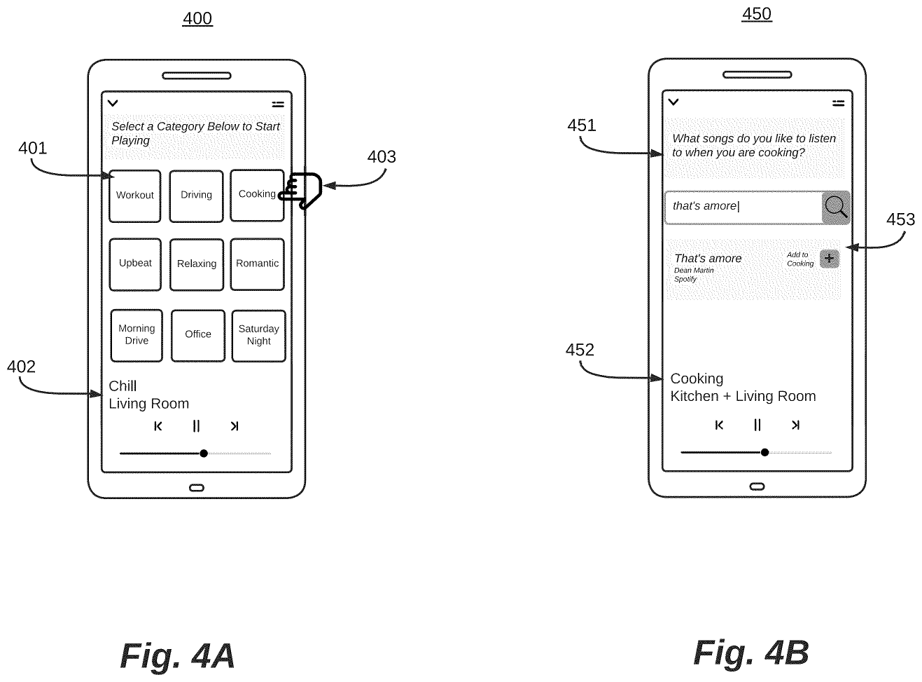

FIG. 4A illustrates a first example graphical user interface 400 comprising graphical representations of different categories, such as graphical representation 401. These graphical representations can correspond to any categories from the list of categories received in block 302 of flowchart 350 in FIG. 3. As illustrated, the graphical user interface can display additional data such as a “now playing” indication 402 corresponding to a category (“Chill”) currently selected for playback by one or more playback devices (the Living Room zone). Graphical user interface 400 can be displayed by any device such as user devices 230a and 230b. The interface can be accessed, for example, via an application and/or web interface of the media service. The user can be able to access their accounts and/or the interface by logging into their account via the application and/or web interface, such that the device is “associated” with the account.

Referring back to FIG. 3, flowchart 350 includes a block 306 of receiving an input indicating at least one sample media item corresponding to at least one category. The input can be received via the graphical interface, for example via a graphical representation corresponding to the at least one category (e.g., touch input 403 in FIG. 4A). In some instances, block 306 comprises receiving a selection or other input corresponding to a selection of a particular category. For example, the input can comprise a selection of a graphical representation via a touch screen of the graphical interface. The input can include additional selections/inputs, for example a selection (from a list, and/or by typing, etc.) of the one or more sample media items.

FIG. 4B illustrates a second example graphical user interface 450. This interface could be displayed after the input 403 is detected, so that the user is able to add sample media items (e.g., 453) to the selected category. The interface can provide additional information such as prompts 451 to guide the user through the process of adding sample media items to the category. In some instances, after a category is selected, associated content can start playing back on any selected playback devices. As illustrated, the now playing indication 452 can be updated to show the currently selected category and any playback devices assigned the category (Kitchen and Living Room in this example).

In some instances, sample media items for the different categories can be provided based on the user's playback activity. For example, the user can review their playback history and classify certain media item(s) for a particular category. In some instances, the users can classify media items as they are selected for playback and/or are currently played back. For example, a “now playing” region in the user interface could provide an option to select a category for a currently playing back media item. This classification could also happen retroactively (e.g., after media items have been played back). For example, the user could be able to review their playback history and select media items as sample media items for a category. The media service could also recommend categories to be associated with certain media items based on contextual data. For example, if it is determined that the user listens to a particular media item while at the gym, the media service could recommend adding the media item as a sample for a workout category. Similarly, if it is determined that the user listens to news podcasts first thing in the morning, the media service could recommend adding samples of podcasts that the user enjoys to a “morning coffee” category.

In any case, users can ignore and/or skip the process of providing samples and/or selecting categories. Similarly, users can ignore and/or skip and/or delete categories at will (e.g., categories that they don't find relevant). In some instances, the process of customizing the categories occurs upon request. For example, the user could select an option on a user interface to be provided with the categories and/or provide the sample media items. If the user does not wish to engage in the process of providing sample media items for the categories, the user may simply forgo and/or “snooz” this option in the user interface and/or remove the option completely from the user interface.

Referring back to FIG. 3, flowchart 350 includes a block 308 of transmitting, to the media service, an indication of the at least one sample media item corresponding to the at least one category. The indication can be an indication corresponding to any category(ies) and/or media item(s) selected in block 306. This indication can be sent in one or more messages and comprise an identifier for the one or more media items. For example, the indication can comprise a URL for the media item(s) or metadata to identify the media item such as a media item identifier, a name, an artist, a content provider, etc. The indication can also include an indication for the category for which the sample media item is being provided, and/or an indication of the account providing the sample media item (e.g., a token to authenticate the account).

As illustrated in flowchart 300, the indication transmitted in block 308 can be received by the media service as described for the execution of block 202 of method 200 (introduced with reference to FIG. 2). The remaining blocks of method 300 can be the same or similar to the blocks in method 200. The media service can then continue to perform the other blocks in method 200 to provide the media content recommendations. The media content recommendations can be received by the user/user accounts, as indicated in block 310 of method 350. The media content recommendations can be received by the same device via which the sample media items were selected, or via any other devices. For example, the sample media items could have been selected via a user device such as devices 230a/230b, and the content recommendations can be provided via a playback device, such as playback devices 210a/210b.

In some instances, block 310 can comprise detecting a trigger such as receiving an input to start playback of media content associated with at least one category. The input can be received via any device associated/registered with the user/account. The computing system can, based on the input, cause a playback device to stream, from the computing system or other service, media content corresponding to the at least one category. The media content is based on the at least one sample media item.

In some instances, one or more categories can be obtained from the users. For example, each user may be able to create categories and provide corresponding sample media items. In some instances, categories can be crowdsourced from a plurality of users/accounts. For example, if a threshold number/percentage of users created a similar custom category (e.g. “bath time”) that isn't in a list of categories provided by the media service, the media service could add that as a category to the list of default/standard categories.

### Associating Sample Media Item(s) With Category

Referring back to FIG. 2, flowchart 200 includes a block 204 of associating the sample media items received in block 201 with the particular category for each of the accounts. Block 204 can include generating the association and/or storing the association in a data storage. The association can be in the form of a data structure that comprises one or more of account identifiers, categories identifiers and/or sample media items identifiers.

An indication of the sample media items identified in block 202 can then be stored in association with the respective accounts that provided the samples and the corresponding category. In some instances, associating a particular category with respective sample media items involves storing an association between the account that provided the sample media item(s), the particular category and the respective sample media item(s). In some instances, associating the particular category with the respective sample media item(s) comprises storing an association between the particular category and identifier(s) corresponding to the respective sample media item(s). In some instances, associating the particular category with the respective sample media item(s) comprises causing a remote computing device to store the association. For example, the media service 220 could send the association and/or cause another service (e.g., a streaming service) to store/generate the association. In this way, the different services can use the association to provide media content recommendations.

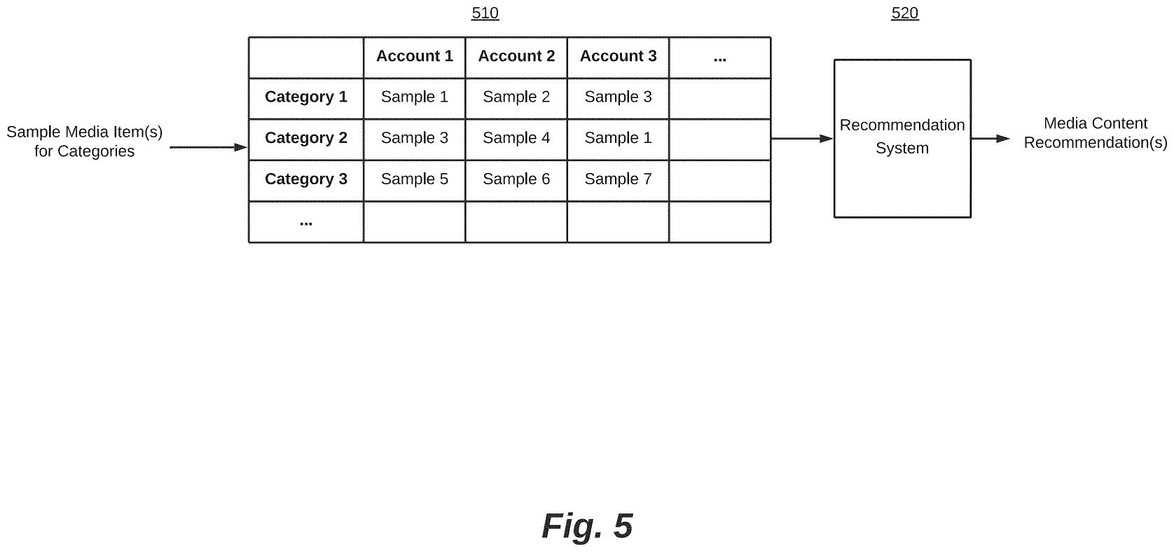

FIG. 5 includes example associations in a data structure 510. The associations can be stored in the same data structure 510 or in different data structures. As illustrated, for the first account 201a, the at least one first sample media item Sample 1 is associated with the particular Category 1. Similarly, for the second account 201b, the at least one second sample media item Sample 2 is associated with the particular Category 1. Other associations for other categories and for other accounts can be created in the same way.

The association can be stored in a data storage accessible to the media service. In some instances, the associations can be stored locally for each account (e.g., in a user device or playback device registered with the account). In some instances, the associations can be distributed among different devices such as user devices, computing systems of the media service, and/or other computing systems such as computing systems of other services.

In some instances, the media service 220 can act as an intermediary and/or aggregator between multiple other services. For example, media service 220 can be a media playback system service provided by the media playback system provider to manage different aspects of the media playback system. Other services, such as streaming services, can be associated with the media service so that users can play back content from any content source they prefer. In this way, sample media items provided by the users can be from different content sources and/or services. The media service 220 can use the associations 510 to determine the sample media items and recommend content from the same service associated with the sample and/or other services. An indication of the source of the sample media item could be stored as part of the data stored in association 510.

### Providing Media Content Recommendations Based on Sample Media Item(s)

Referring back to FIG. 2, flowchart 200 includes a block 206 of providing media content recommendations for a particular category. The media content recommendations can be based on the sample media items received in block 202 from each account. More specifically, the media content recommendations can be based on the associations generated in block 204. For example, the media content recommendations for a user/account can be based on the association between the particular category and any sample media item received in association with that category for that user/account.

In this way, block 206 can include providing, for the first account 201a, at least one first media content recommendation (Recommendation 1) for the particular category (e.g., Category 1) as indicated by example arrow 252a, based on the association between the particular category and the at least one first sample media item (Sample 1). Similarly, block 206 can include providing, for the second account 201b, at least one second media content recommendation (Recommendation 2) for the particular category (Category 1) as indicated by example arrow 252b, based on the association between the particular category and the at least one second sample media item (Sample 2).

Media content recommendations can be provided in various ways. In some instances, media content recommendations in block 206 can be provided by causing at least one playback device associated with the corresponding account to play back at least one media item corresponding to the media content recommendation. In some instances, the media item can be added and/or caused to be added to a playback queue associated with the account (e.g., a queue assigned to a playback device registered with the account). The media item could also or alternatively be added to a playlist for the corresponding account (for example a playlist associated with the particular category). In some instances, media content recommendations in block 206 can be provided via a user interface associated with the corresponding account. For example, by displaying, via a graphical user interface of a device associated/registered with the corresponding account, one or more graphical representations corresponding to media content recommendations.

The media content recommendations can comprise one or more media items and/or indications of the one or more media items (e.g., graphical representations corresponding to the media items). The media item(s) in the recommendation provided in block 206 for a particular account can have at least one characteristic in common with at least one of the sample media items provided by the particular account. The common characteristic can include any one or more of: a style, an artist, a genre, a mood, a tempo, etc. or any combination thereof. In this way, the media item(s) in the recommendations provided in block 206 can have similarities with the sample media item(s) received in block 202. In some instances, the media items in the recommendations provided in block 206 can have at least one characteristic which is different from the sample media item(s) received in block 202. For example, recommended media items can be from different artists and/or genres than the sample media item(s). Recommended media item(s) and sample media item(s) can be different in at least one aspect while still being similar in at least one other aspect. For example, recommended media items can be from different artists and/or genres than the sample media item(s) but have a similar tempo and/or style.

Since the media items received from the different users/accounts in block 202 can be different, in some instances recommendations provided to different users/accounts for a given category can likewise be different. For example, the at least one second media content recommendation (Recommendation 2) provided to the second user 203b/account 201b can be different from the at least one first media content recommendation (Recommendation 1) provided to the first user 203a/account 201a. Similarly, since the media items received from the different users/accounts in block 202 can be the same and/or similar in at least one aspect (e.g., different media items by the same artist, or of the same genre, etc.), recommendations provided to different users/accounts for a given category can likewise be the same and/or similar. For example, two different users who provide different sample media items with a common characteristic (e.g., a same artist) could be recommended a same media item in block 206 (e.g., a third media item from the artist).

In some instances, the content recommendations provided in block 206 can be based on additional factors. For example, the content recommendations can take into consideration other contextual data in addition to the sample media items provided by the user. In this way, media content recommendations can, while still being based on the samples, be further curated for a specific context such as time of the day (e.g., “driving” to work during rush hours in the morning may call for a slightly different content than “driving” to a family dinner in the evening), user's presence detection, etc. Example techniques for contextual media content recommendations are described in U.S. Provisional Patent Application Ser. No. 63/523,752 filed on Jun. 28, 2023 and entitled “CONTEXTUAL MEDIA CONTENT RECOMMENDATIONS,” which application is expressly incorporated herein by reference in its entirety. Additionally or alternatively, the content recommendations may take into consideration the categories themselves. For example, content recommendations for a workout category can be based on both the sample media items provided by the user and related media content in the workout category.

In any case, since content recommendations for the different categories are based on sample media items provided by the users, content recommendations can be better refined and personalized. Users can enjoy content they find relevant to each category rather than listening to recommendations based on what other users or content providers find relevant for the category. These approaches provide the users freedom to customize their playback experiences to make them more enjoyable and intuitive.

Media content recommendations can be provided by a recommendation system. The recommendation system can include one or more recommendation engines trained to provide media content recommendations based on a sample/reference set of media items used as seeds and/or any other data. For example, the recommendation engines could be trained to provide recommendations on media content that is similar to the sample media content. Media content can be similar in multiple ways, for example media content with similar and/or common characteristics, similar and/or common attributes, similar and/or common metadata etc. (e.g., similar or common name, topic, artist, genre, tempo, age rating, etc.). With reference to FIG. 5, the media service 220 can be configured to pull data from the associations 510 and “feed” that data to a recommendation system 520. For example, the media service 220 could pull data corresponding to sample media items associated with a particular category for a given account, and provide the indication of the sample media item(s) to the recommendation system for generation of media content recommendations for that account and category.

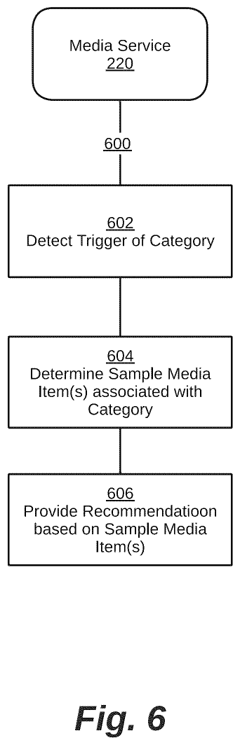

In some instances, the media content recommendations are provided passively to the user. For example, the recommendations can be displayed in a user interface when the user accesses their account via an application or web interface of the media service. In other instances, recommendations can be provided in response to and/or based on a trigger, such as a user input and/or user request. FIG. 6 includes a flowchart 600 for a set of methods of providing media content recommendations based on a trigger.

Flowchart 600 comprises a block 602 of detecting a trigger to provide content recommendations for a particular category. The trigger can comprise receiving, from an account of a media service, a request for media content associated with a particular category. The trigger can comprise any other trigger and/or event associated with a particular account and a particular category. For example, an event could be a selection, via a user interface associated with an account, of a graphical representation corresponding to the particular category (such as input 403 in FIG. 4A). As another example, an event could be a detection of an activity associated with the particular category. The media service could determine that the user has engaged/will engage in an activity (for example detecting a workout activity from data received from a fitness tracker or other fitness equipment, detecting a driving activity based on data received from the car media playback system, detecting a cooking activity based on the selection/activation of a kitchen playback device, etc.). As another example, an event could be a detection of a mood associated with the particular category. A mood can be detected from data from other devices and/or data collected from user interactions (e.g., emotions detected in a user voice command). An event could also be a detection of a playback context associated with the particular category. The playback context can be determined by determining, for example, a playback device used for playback, the time of the day, whether there are users in the playback environment, how many users, what users, etc. Example techniques for context determination are described in U.S. Provisional Patent Application Ser. No. 63/523,752 filed on Jun. 28, 2023 and entitled “CONTEXTUAL MEDIA CONTENT RECOMMENDATIONS,” which application is expressly incorporated herein by reference in its entirety.

Flowchart 600 comprises a block 604 of determining the sample media item(s) provided by the account for the particular category. These can be any media items received in block 202 of flowchart 200 and stored in association with the particular category for the account. At this point, the media service could fetch and/or otherwise consult the associations stored in block 204 of method 204 and use the indications of the sample media items as seeds to generate content recommendations.

Flowchart 600 comprises a block 606 of providing at least one first media content recommendation based on the at least one sample media item. This block can be the same or similar to block 206 of flowchart 200. In this way, media content recommendations in a particular category provided for a first account can be different from media content recommendations in the particular category for a second account that provided different sample media item(s).

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A computing system comprising:
at least one processor; and
at least one non-transitory computer-readable medium comprising program instructions that are executable by the at least one processor such that the computing system is configured to:
receive, for a first account in a plurality of accounts of a media service, an indication of at least one first sample media item to be associated with a particular category;
receive, for a second account in the plurality of accounts of the media service, an indication of at least one second sample media item to be associated with the particular category, wherein the at least one first sample media item is different from the at least one second sample media item;
associate, for the first account, the at least one first sample media item with the particular category;
associate, for the second account, the at least one second sample media item with the particular category;
based on the association between the particular category and the at least one first sample media item, provide for the first account at least one first media content recommendation for the particular category; and
based on the association between the particular category and the at least one second sample media item, provide for the second account at least one second media content recommendation for the particular category, wherein the at least one second media content recommendation is different from the at least one first media content recommendation.

2. The computing system of claim 1, wherein the particular category comprises one or more of: an activity, a mood, or a playback context.

3. The computing system of claim 2, wherein the playback context is determined based on one or more of: a playback device via which media content is to be played back, a location in which media content is to be played back, or a time at which media content is to be played back.

4. The computing system of claim 1, wherein associating the particular category with the respective at least one first sample media item comprises storing an association between the first account, the particular category and the respective at least one first sample media item.

5. The computing system of claim 1, wherein associating the particular category with the respective at least one first sample media item comprises storing an association between the particular category and an identifier corresponding to the respective at least one first sample media item.

6. The computing system of claim 1, wherein associating the particular category with the respective at least one first sample media item comprises causing a remote computing device to store an association between the particular category and the respective at least one first sample media item.

7. The computing system of claim 1, wherein providing the at least one first media content recommendation comprises displaying, via a graphical display associated with the first account, at least one graphical representation corresponding to the at least one first media content recommendation.

8. The computing system of claim 1, wherein providing the at least one first media content recommendation comprises causing at least one media item associated with the at least one first content recommendation to be added to a playback queue of the first account.

9. The computing system of claim 1, wherein providing the at least one first media content recommendation comprises causing at least one media item associated with the at least one first content recommendation to be added to a playlist of the first account, the playlist associated with the particular category.

10. The computing system of claim 1, wherein the at least one first media content recommendation comprises at least one media item, and the at least one media item has at least one characteristic in common with the at least one first sample media item.

11. The computing system of claim 1, wherein providing the at least one first media content recommendation comprises playing back, via at least one playback device associated with the first account, at least one media item corresponding to the at least one first media content recommendation.

12. The computing system of claim 1, wherein the program instructions include instructions that are executable to configure the computer system to:
receive, from a third account in the plurality of accounts of the media service, an indication of at least one third sample media item to be associated with the particular category, wherein the at least one third sample media item is different from the at least one first sample media item;
associate, for the third account, the at least one this sample media item with the particular category; and
based on the association between the particular category and the at least one third sample media item, provide for the third account at least one third media content recommendation for the particular category;
wherein the at least one third media content recommendation is the same as the at least one first media content recommendation.

13. The computing system of claim 1, wherein providing the at least one first media content recommendation comprises providing the at least one first media content recommendation based on an event associated with the first account and the particular category.

14. The computing system of claim 13, wherein the event comprises a selection, via a user interface associated with the first account, of a graphical representation corresponding to the particular category.

15. The computing system of claim 13, wherein the event comprises a detection of an activity associated with the particular category.

16. The computing system of claim 1, further comprising:
before receiving the indication of at least one sample media item to be associated with the particular category from each account in a plurality of accounts, transmit, to each account in the plurality of accounts, a list of categories comprising at least the particular category.

17. The computing system of claim 1, further comprising:
before receiving the indication of at least one sample media item to be associated with the particular category from each account in a plurality of accounts, cause respective user interfaces of each account in the plurality of accounts to display a graphical representation corresponding to the particular category.

18. The computing system of claim 17, wherein receiving the indication of at least one sample media item comprises receiving the indication via the graphical representation.

19. A computer-implemented method comprising:
receiving, for a first account in a plurality of accounts of a media service, an indication of at least one first sample media item to be associated with a particular category;
receiving, for a second account in the plurality of accounts of the media service, an indication of at least one second sample media item to be associated with the particular category, wherein the at least one first sample media item is different from the at least one second sample media item;
associating, for the first account, the at least one first sample media item with the particular category;
associating, for the second account, the at least one second sample media item with the particular category;
based on the association between the particular category and the at least one first sample media item, providing for the first account at least one first media content recommendation for the particular category; and
based on the association between the particular category and the at least one second sample media item, providing for the second account at least one second media content recommendation for the particular category, wherein the at least one second media content recommendation is different from the at least one first media content recommendation.

20. A computer-readable media comprising one or more non-transitory computer-readable storage media having stored thereon computer-executable instructions that, when executed at a processor, cause a computer system to perform a method for contextual media content recommendations, the method comprising:
receiving, for a first account in a plurality of accounts of a media service, an indication of at least one first sample media item to be associated with a particular category;
receiving, for a second account in the plurality of accounts of the media service, an indication of at least one second sample media item to be associated with the particular category, wherein the at least one first sample media item is different from the at least one second sample media item;
associating, for the first account, the at least one first sample media item with the particular category;
associating, for the second account, the at least one second sample media item with the particular category;
based on the association between the particular category and the at least one first sample media item, providing for the first account at least one first media content recommendation for the particular category; and
based on the association between the particular category and the at least one second sample media item, providing for the second account at least one second media content recommendation for the particular category, wherein the at least one second media content recommendation is different from the at least one first media content recommendation.
